(19) United States
(12) Patent Application Publication
(10) Pub. No.: US 2014/0161497 A1
(43) Pub. Date: Jun. 12, 2014

(54) FIXING DEVICE AND ELECTROPHOTOGRAPHIC IMAGE FORMING APPARATUS USING THE SAME

(71) Applicant: SAMSUNG ELECTRONICS CO., LTD., Suwon-si (KR)

(72) Inventors: Dong-woo LEE, Seoul (KR); Soo-hwan Bae, Seoul (KR)

(73) Assignee: SAMSUNG ELECTRONICS CO., LTD., Suwon-si (KR)

(21) Appl. No.: 13/897,761

(22) Filed: May 20, 2013

(30) Foreign Application Priority Data
Dec. 10, 2012 (KR) 10-2012-0143030

(51) Int. Cl. G03G 15/20

(52) U.S. Cl. CPC G03G 15/2064
USPC 399/329

(57) ABSTRACT

A fixing device and an image forming apparatus including the same are provided. The fixing device includes a rotatable endless belt passing through a fixing nip that is formed by a nip forming member and a backup member, and a first guide positioned inside the endless belt to guide the endless belt entering the fixing nip, wherein the first guide includes a first bent portion disposed at an upstream side of the fixing nip to support the endless belt and a second bent portion disposed at an upstream side of the first bent portion to support the endless belt, and a height of the second bent portion from the fixing nip is within a range of about 4% to about 10% of a height of the endless belt when being freely transformed.

### CROSS-REFERENCE TO RELATED APPLICATIONS

This application is related to, and claims priority to, Korean Patent Application No. 10-2012-0143030, filed on Dec. 10, 2012, in the Korean Intellectual Property Office, the disclosure of which is incorporated herein in its entirety by reference.

### BACKGROUND

1. Field

Embodiments of present invention relate to a fixing device using a rotating endless belt and an electrophotographic image forming apparatus having the same.

2. Description of the Related Art

An image forming apparatus using an electrophotographic method supplies toner to an electrostatic latent image formed on an image receptor to form a visible toner image on the image receptor, transfers the visible toner image to a recording medium, and fixes the transferred toner image onto the recording medium. The toner may be manufactured by adding various types of additives including coloring to a base resin. A fixing process includes a process of applying heat and pressure to the toner.

In general, a fixing device includes a heating roller and a pressure roller that are engaged with each other to form a fixing nip. The heating roller is heated by a heat source such as a halogen lamp or the like. When the recording medium, to which the toner is transferred, passes through the fixing nip, heat and pressure are applied to the toner. Since in the fixing device, the heat source heats the heating roller and heat is transferred to the toner through the recording medium, high heat transfer efficiency may be difficult to achieve. A heat capacity of the heating roller, which is a heating member to be heated, is large. Thus, facilitating a fast temperature rise may be difficult.

### SUMMARY

Additional aspects and/or advantages will be set forth in part in the description which follows and, in part, will be apparent from the description, or may be learned by practice of the invention.

According to an aspect of the present invention, a fixing device is provided using an endless belt and enabling a stable drive of the endless belt and an image forming apparatus using the same.

According to an aspect of the present invention, a fixing device is provided for reducing the risk of breakage of the endless belt and an image forming apparatus using the same.

According to an aspect of the present invention, a fixing device is provided including an endless belt that is rotatable, a backup member disposed outside the endless belt to drive the endless belt, a nip forming member positioned inside the endless belt to be opposite to the backup member to form a fixing nip, and a first guide positioned inside the endless belt to guide the endless belt entering the fixing nip, wherein the first guide comprises a first bent portion disposed at an upstream side of the fixing nip to support the endless belt and a second bent portion disposed at an upstream side of the first bent portion to support the endless belt, based on a driving direction of the endless belt, and a height of the second bent portion from the fixing nip is within a range of about 4% to about 10% of a height of the endless belt when being freely transformed.

When a torsional force acting on the endless belt in the second bent portion has a value of F and a component force in a normal direction of the torsional force has a value of Fn, the ratio Fn/F of Fn to F may be less than 0.5.

The fixing device may include a second guide positioned inside the endless belt to guide the endless belt exiting from the fixing nip, wherein the second guide comprises a third bent portion disposed at a downstream side of the fixing nip to support the endless belt.

A height of the first bent portion from the fixing nip may be equal to that of the third bent portion from the fixing nip.

The fixing device may include a protrusion portion protruding towards the backup member with respect to the fixing nip, the protrusion portion being disposed between the third bent portion and the fixing nip.

The second guide may include a fourth bent portion positioned at a downstream side of the third bent portion to support the endless belt.

The first guide may extend in a width direction, orthogonal to the driving direction of the endless belt and may have a bent shape that is convex outwards with respect to the fixing nip.

The second guide may extend in a width direction, orthogonal to the driving direction of the endless belt and may have a bent shape that is convex outwards with respect to the fixing nip.

According to an aspect of the present invention, an image forming apparatus is provided including a printing unit that forms a visible toner image on a recording medium, and a fixing device according to an exemplary embodiment of the present invention.

According to an aspect of the present invention, a fixing device is provided including an endless belt that is rotatable, a backup member disposed outside the endless belt to drive the endless belt, a nip forming member positioned inside the endless belt to be opposite to the backup member to form a fixing nip, and a first guide positioned inside the endless belt to guide the endless belt entering the fixing nip, wherein the first guide extends in a width direction, orthogonal to a driving direction of the endless belt and has a bent shape that is convex outwards with respect to the fixing nip.

The first guide may include a first bent portion disposed at an upstream side of the fixing nip to support the endless belt and a second bent portion disposed at an upstream side of the first bent portion to support the endless belt, based on a driving direction of the endless belt.

A height of the second bent portion from the fixing nip may be within a range of about 4% to about 10% of a height of the endless belt when being freely transformed.

When a torsional force acting on the endless belt in the second bent portion having a value of F and a component force in a normal direction of the torsional force having a value of Fn, the ratio Fn/F of Fn to F may be less than 0.5.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating an electrophotographic image forming apparatus according to an exemplary embodiment of the present invention;

FIG. 2 illustrates an exemplary fixing device of an electrophotographic image forming apparatus according to an embodiment of the present invention;

FIG. 3 illustrates an exemplary endless belt according to an embodiment of the present invention;

FIG. 4 illustrates a first guide according to an exemplary embodiment of the present invention;

FIG. 5 illustrates an exemplary position of a second bent portion according to an embodiment of the present invention;

FIG. 6 illustrates exemplary freely transformed forms of an endless belt according to a size of a fixing nip, according to an embodiment of the present invention;

FIG. 7 illustrates an exemplary height of an endless belt according to the size of a fixing nip, according to an embodiment of the present invention;

FIG. 8 illustrates a fixing device according to an exemplary embodiment of the present invention;

FIG. 9 illustrates an exemplary case in which an endless belt inclines, according to an embodiment of the present invention;

FIG. 10 illustrates first and second guides having a bent shape that is convex outwards, according to an exemplary embodiment of the present invention; and

FIG. 11 illustrates an exemplary fixing device using a surface type heating element, according to an exemplary embodiment of the present invention.

### DETAILED DESCRIPTION

Exemplary embodiments of the present invention are described more fully with reference to the accompanying drawings, in which exemplary embodiments of the present invention concept are illustrated.

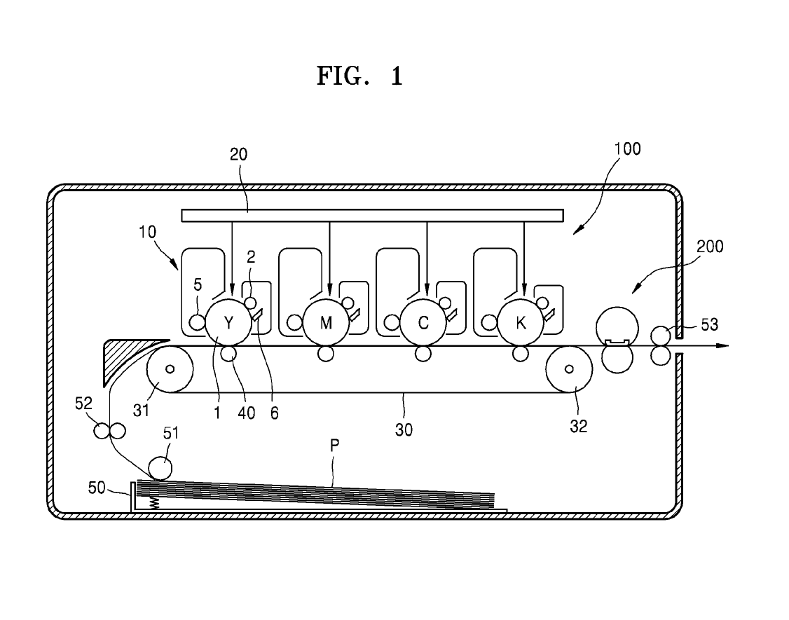

FIG. 1 illustrates an electrophotographic image forming apparatus according to an exemplary embodiment of the present invention. As illustrated in FIG. 1, the electrophotographic image forming apparatus includes a printing unit 100 that forms a visible toner image on a recording medium P, e.g., a paper sheet, and a fixing device 200 that fixes the visible toner image onto the recording medium P. The printing unit 100 according to an exemplary embodiment forms a color toner image through an electrophotographic method.

The printing unit 100 includes a plurality of photoconductive drums 1, a plurality of developers 10, and a paper-transporting belt 30. The photoconductive drums 1 may be photoreceptors having surfaces on which electrostatic latent images are formed, wherein the photoconductive drums 1 include conductive metal pipes and photosensitive layers formed on outer surfaces of the conductive metal pipes. The plurality of developers 10 respectively correspond to the plurality of photoconductive drums 1 and supply toner to electrostatic latent images formed on the plurality of photoconductive drums 1 to develop the electrostatic latent images into toner images on surfaces of the plurality of photoconductive drums 1. The plurality of developers 10 may be respectively replaced separately from the plurality of photoconductive drums 1. The plurality of developers 10 may respectively be in the form of cartridges including the photoconductive drums 1.

For color printing, the plurality of developers 10 respectively include a plurality of developers 10Y, 10M, 10C, and 10K containing yellow (Y), magenta (M), cyan (C), and black (K) color toners, respectively. However, an embodiment of the present invention is not limited thereto, and developers containing various colors of toners such as light magenta, white, etc. besides the above-mentioned colors may be included. An image forming apparatus including the plurality of developers 10Y, 10M, 10C, and 10K is disclosed. Unless indicated otherwise herein, elements denoted by the reference characters Y, M, C, and K refer to elements for printing an image by using Y, M, C, and K color toners.

The developer 10 supplies the toner contained therein to the electrostatic latent image formed on the photoconductive drum 1 to develop the electrostatic latent image as the visible toner image. The developer 10 may include developing roller 5. The developing roller 5 supplies the toner of the developers 10 to the photoconductive drums 1. A developing bias voltage may be applied to the developing roller 5. A regulating member (not shown) regulates an amount of toner supplied to developing area where the photoconductive drum 1 and the developing roller 5 face each other, by the developing rollers 5.

If a two-component developing method is used, magnetic carrier may be contained in the developer 10, and the developing roller 5 rotates while keeping distance of tens to hundreds of microns from the photoconductive drum 1. Although not illustrated in FIG. 1, the developing roller 5 may have a shape in which magnetic roller is arranged in hollow cylindrical sleeve. The toner sticks onto surface of the magnetic carrier. The magnetic carrier sticks onto the surface of the developing roller 5 to be transferred to the developing area. Only the toner may be supplied to the photoconductive drum 1 due to the developing bias voltage applied between the developing roller 5 and the photoconductive drum 1 to develop the electrostatic latent image formed on the surface of the photoconductive drum 1 as the visible toner image. If the two-component developing method is used, the developer 10 may include an agitator (not shown) for mixing and agitating the toner with carrier and transporting the mixed toner and carrier to the developing rollers 5. The agitator may be an auger, and a plurality of the agitators may be included in the developer 10.

If a one-component developing method that does not use carrier is used, the developing roller 5 may rotate in contact with the photoconductive drum 1 or rotate at a position separate from the photosensitive drum 1 by tens through hundreds microns. The developer 10 may further include a supplying roller (not shown) which sticks the toner onto the surface of the developing roller 5. A supply bias voltage may be applied to the supplying roller. The developer 10 may further include an agitator (not shown). The agitator may agitate and tribo-electrify the toner. The agitator may be an auger.

The charging roller 2 is an example of a charger that charges the photoconductive drum 1 so that the photoconductive drum 1 has uniform surface potential. A charging brush, a corona charger, or the like may be used instead of the charging roller 2.

A cleaning blade 6 is an example of a cleaning device that removes toner and foreign matter remaining on the surface of the photoconductive drum 1 after a transferring process. Instead of the cleaning blade 6, other types of cleaning device such as rotating brush or the like may be used.

An example of a developing method of an image forming apparatus according to an embodiment of the present invention has been described in detail. However, an embodiment of the present invention is not limited thereto, and the developing method may be variously modified.

An exposer 20 irradiates light modulated to correspond to image information onto photoconductive drums 1Y, 1M, 1C, and 1K to form electrostatic latent images respectively corresponding to Y, M, C, and K color images on the photoconductive drums 1Y, 1M, 1C, and 1K. Representative examples of the exposer 20 may include a laser scanning unit using a laser diode as a light source, a light-emitting diode (LED) exposer using an LED as a light source, etc.

The paper-transporting belt 30 supports and transports the recording media P. The paper-transporting belt 30 may be supported by, for example, support rollers 31 and 32, and circulates. A plurality of transfer rollers 40 may be disposed to respectively face the plurality of photoconductive drums 1Y, 1M, 1C, and 1K with the paper-transporting belt 30 therebetween. The plurality of transfer rollers 40 are examples of a transfer unit which transfers the toner images from the plurality of photoconductive drums 1Y, 1M, 1C, and 1K to the recording media P supported by the paper transfer belt 30. A transfer bias voltage may be applied to the plurality of transfer rollers 40 to transfer the toner images to the recording media P. A corona transfer unit or a pin scorotron type transfer unit may be used instead of the transfer rollers 40.

The recording media P may be picked up from a loading station 50 by a pickup roller 51 and is transported by a transporting roller 52, and is attached to the paper-transporting belt 30 by an electrostatic force.

The fixing device 200 applies heat and/or pressure to the toner image transferred to the recording medium P to fix the toner image onto the recording medium P. The recording medium P passing through the fixing device 200 is discharged by a discharge roller 53.

The exposer 20 scans a plurality of light rays, which are modulated to correspond to image information of colors, onto the plurality of photoconductive drums 1Y, 1M, 1C, and 1K to form the electrostatic latent images. A plurality of developers 10Y, 10M, 10C, and 10K respectively supply Y, M, C, and K color toners to the electrostatic latent images on the plurality of photoconductive drums 1Y, 1M, 1C, and 1K to form Y, M, C, and K color visible toner images on the surfaces of the plurality of photoconductive drums 1Y, 1M, 1C, and 1K. The recording medium P loaded on the loading station 50 may be fed to the paper-transporting belt 30 through the pickup roller 51 and the transporting roller 52 and maintained on the paper transfer belt 30 by electrostatic force. The Y, M, C, and K color toner images may be sequentially transferred onto the recording medium P, which is transported by the paper transfer belt 30, due to the transfer bias voltage applied to the transfer rollers 40. If the recording medium P passes through the fixing device 200, the toner images are fixed on the recording medium P by heat and pressure. The recording medium P on which the fixing is completed may be discharged by a discharge roller 53.

The electrophotographic image forming apparatus illustrated in FIG. 1 may use a method of directly transferring the toner images developed on the plurality of photoconductive drums 1Y, 1M, 1C, and 1K to the recording medium P supported by the paper-transporting belt 30. However, the scope of the present invention is not limited to this. For example, the electrophotographic image forming apparatus may use an intermediate transfer method in which the toner images developed on the plurality of photoconductive drums 1Y, 1M, 1C, and 1K are intermediately transferred to an intermediate transfer belt and then transferred the toner images to the recording medium P.

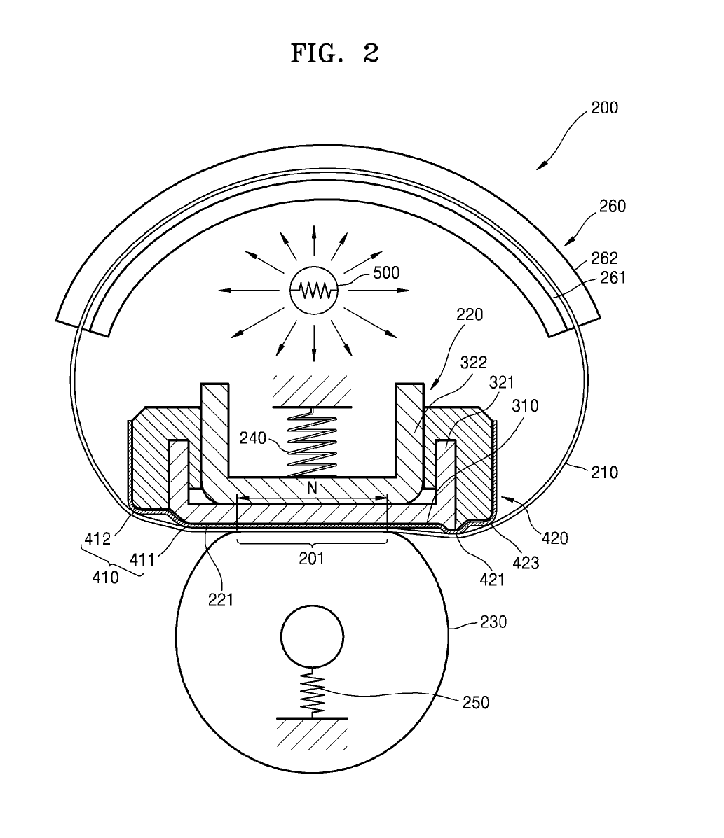

The fixing device 200 applies heat and pressure to the toner images to fix the toner images onto the recording medium P. A heat capacity of a heating part of the fixing device 200 may be small to improve a printing speed and reduce energy consumption. The fixing device 200 may use a thin film-shaped endless belt as the heating part. FIG. 2 illustrates an exemplary fixing device 200 according to an embodiment.

Referring to FIG. 2, the fixing device 200 includes an endless belt 210, a nip forming member 220 that is positioned inside the endless belt 210, and a backup member 230 that is positioned outside the endless belt 210 to be opposite to the nip forming member 220 in order to form a fixing nip 201. The backup member 230 may be pressurized with respect to the nip forming member 220 with the endless belt 210 therebetween and rotates in order to rotate the endless belt 210.

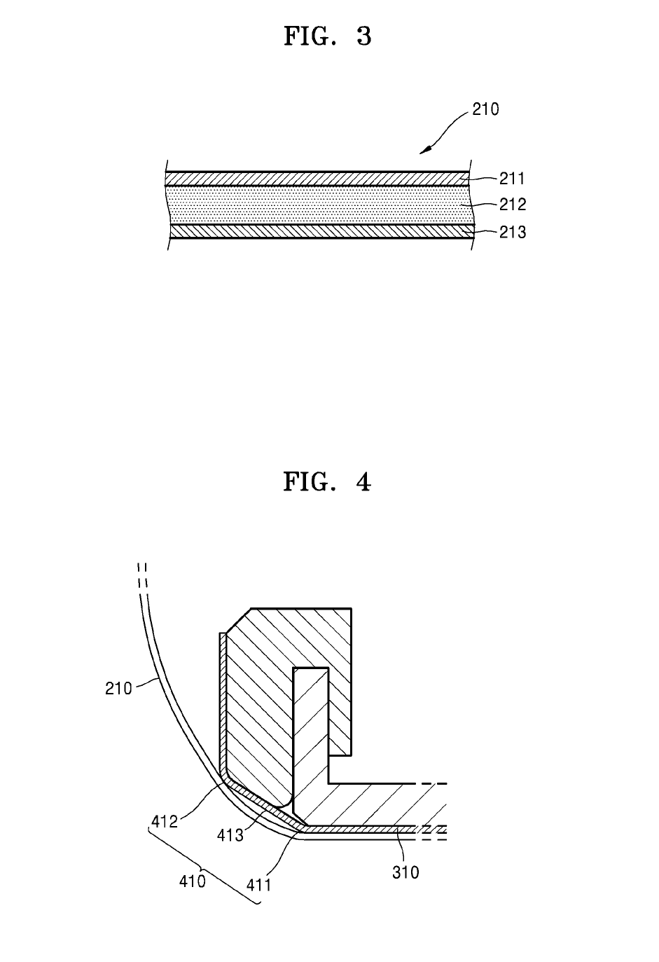

FIG. 3 illustrates a cross-sectional view of the endless belt 210 according to an exemplary embodiment of the present invention. As illustrated in FIG. 3, the endless belt 210 includes a substrate 211 having a film form. The substrate 211 may be a metal thin film such as a stainless steel thin film and a nickel thin film, or a polymer film having a heat resistance and a wear resistance at a fixing temperature, e.g., a temperature range of about 120° C.-200° C., such as a polyimide film, a polyamide film, a polyimideamide film, or the like. A thickness of the substrate 211 may be determined so that the endless belt 210 has flexibility and elasticity to be capable of being flexibly deformed on the fixing nip 201 and returning to its original state after getting out of the fixing nip 201. For example, a stainless steel thin film having a thickness of about 35 microns may be used as the substrate 211.

An outermost layer of the endless belt 210 may be a release layer 213. An offset, in which toner on the recording medium P melts in a fixing process and attaches to the endless belt 210, may occur. The offset may cause a printing defect whereby a part of a printed image on the recording medium P is omitted, or a jam in which the recording medium P getting out of the fixing nip 201 is not separated from the endless belt 210 and sticks on an outer surface of the endless belt 210. The release layer 213 may be a resin layer having high separation characteristics. The release layer 213 may be, for example, one of perfluoroalkoxy (PFA), polytetrafluoroethylenes (PTFE), and fluorinated ethylene prophylene (FEP), a blend of two or more thereof, or a copolymer thereof.

The endless belt 210 may include an elastic layer 212. The elastic layer 212 may be interposed between the substrate 211 and the release layer 213. The elastic layer 212 may be used to form the fixing nip 201 and may be formed of a material having a heat resistance to a fixing temperature. For example, the elastic layer 212 may be silicone polymer. A thickness of the elastic layer 212 may be about 200 μm.

The nip forming member 220 may be arranged inside the endless belt 210. The backup member 230 may be arranged outside the endless belt 210 to be opposite to the nip forming member 220. The nip forming member 220 and the backup member 230 press against each other with the endless belt 210 therebetween. For example, a pressure pushing toward the backup member 230 may be applied to both ends of the nip forming member 220 in a width direction orthogonal to a driving direction of the nip forming member 220 through a pressuring device, e.g., a spring 240. A pressure pushing toward the nip forming member 220 may be applied to the backup member 230 through a pressuring mechanism, e.g., a spring 250. The backup member 230 may rotate the endless belt 210. For example, the backup member 230 may be a pressing roller including an elastic layer formed on an outer surface of a metallic core. The backup member 230 and the nip forming member 220 pressed against each other with the endless belt 210 therebetween and rotate in order to rotate the endless belt 210.

The nip forming member 220 forms the fixing nip 201 together with the backup member 230 and guides the endless belt 210 to rotate. For example, the nip forming member 220 may include a guide plate 310 contacting the inside of the endless belt 210. The guide plate 310 may be supported by at least one supporting member, e.g., first and second supporting members 321 and 322 disposed inside the endless belt 210. The first and second supporting members 321 and 322 reinforce the strength of the guide plate 310 and thus prevent a deformation of the guide plate 310 due to a pressure. The guide plate 310 may include a nip forming portion 221 corresponding to the fixing nip 201. The length of the nip forming portion 221 in a moving direction of the recording medium P may be equal to, or greater than, the length N of the fixing nip 201.

A first guide 410 for guiding the endless belt 210 entering the fixing nip 201 may be disposed at an upstream side of the fixing nip 201 in the driving direction of the endless belt 210. The first guide 410 may be disposed inside the endless belt 210. The first guide 410 includes a first bent portion 411 disposed at an upstream side of the fixing nip 201 and a second bent portion 412 disposed at an upstream side of the first bent portion 411. The second bent portion 412 may be disposed further spaced from the fixing nip 201 in a direction opposite to the backup member 230, compared to the first bent portion 411. For example, the first bent portion 411 may be formed by bending the guide plate 310 from the nip forming portion 221 away from the backup member 230. The second bent portion 412 may be formed by bending the guide plate 310 from the first bent portion 411 away from the backup member 230. Although in FIG. 2, the first bent portion 411 and the second bent portion 412 are arranged in tiers, the present inventive concept is not limited thereto. For example, as illustrated in FIG. 4, the first bent portion 411 and the second bent portion 412 may be connected to each other by an inclined connection portion 413. A single second bent portion 412 may be disposed, or two or more second bent portions 412 may be disposed in an opposite direction of the driving direction of the endless belt 210. The endless belt 210 may be supported via multiple points by the first bent portion 411 and the second bent portion 412 and is guided to the fixing nip 201.

According to an exemplary embodiment, an endless belt 210 may be locally constrained only around the fixing nip 201 and have a freely transformed free curve form due to the hardness thereof in other areas. The endless belt 210 receives a driving force from the backup member 230 to be rotated. Thus, based on the fixing nip 201 of the endless belt 210, an upstream side of the endless belt 210 may be placed in a state of tension and a downstream side of the endless belt 210 may be placed in a relaxed state.

If the endless belt 210 is guided by only a single supporting point (for example, by only the first bent portion 411) at the upstream of the endless belt 210, stress may be concentrated on the single supporting point, and thus, the endless belt 210 may be damaged. If the endless belt 210 is pulled in a moving direction of the recording medium P by an adhesive strength between the endless belt 210 and a toner melted on the recording medium P, the endless belt 210 may not maintain a free state while being driven and may repeat the pulled state and the free state. To maintain the shape of the endless belt 210, both ends of the endless belt 210 in a width direction, orthogonal to a driving direction of the endless belt 210 may be guided by a guide bush 260. The guide bush 260 may include an internal guide portion 261 spaced apart from the inner circumference surface of the endless belt 210 to an inner side of the endless belt 210 and an end guide portion 262 for guiding both ends of the endless belt 210 in the width direction thereof. The guide bush 260 may be disposed only at both end sides of the endless belt 210 in the width direction of the endless belt 210. The endless belt 210 and the guide bush 260 may continuously contact each other, or may repeat contact and separation therebetween. An impact occurring during this process may cause a breakdown or life-shortening of the endless belt 210. Due to friction in the fixing nip 201, a widthwise directional imbalance of a pressure that is applied to the nip forming member 220 and the backup member 230, and an incline of an axial line of the backup member 230 and the endless belt 210, the endless belt 210 may be caused to wobble by a torsional force while being driven. Due to the wobble of the endless belt 210, the endless belt 210 may collide with the guide bush 260. This collision may cause a breakdown or life-shortening of the endless belt 210.

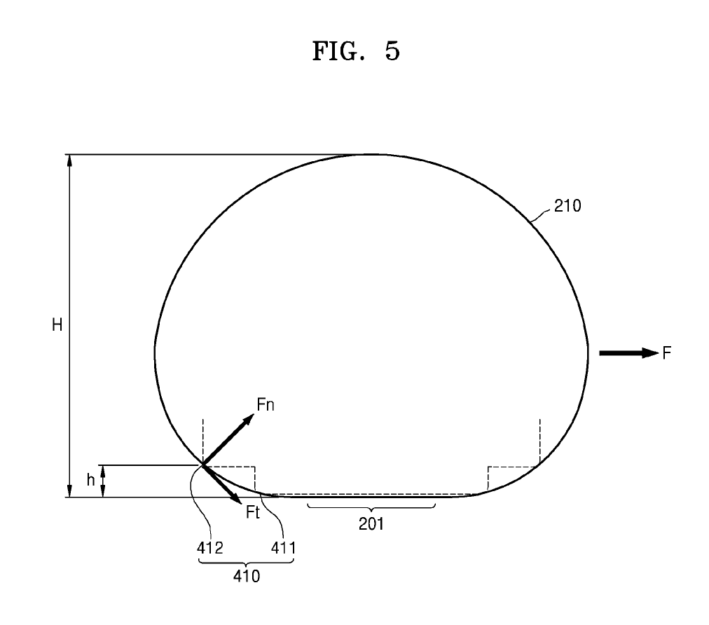

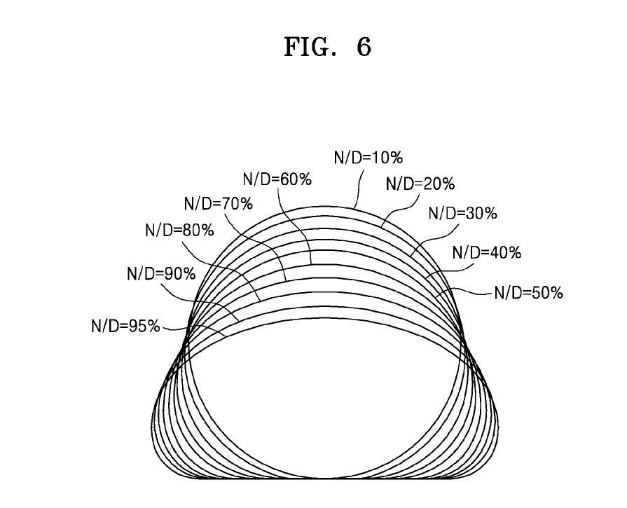

In a state of tension, the inner circumference surface of the endless belt 210 contacts the first and second bent portions 411 and 412. A position of the second bent portion 412 may be determined so that the endless belt 210 may be stably driven while maintaining a free curve form. As illustrated in FIG. 5, a height of the endless belt 210 may have a value H when the endless belt 210 is freely transformed in a state in which the fixing nip 201 is formed. For example, the height H may be indicated as a distance from the fixing nip 201 to the uppermost side of the endless belt 210. The height H may be determined by the diameter D of the endless belt 210, physical properties of the endless belt 210, the length of the fixing nip 201, etc. FIG. 6 illustrates an example of a shape of the endless belt 210 after a free transformation thereof according to a ratio N/D of the length N of the fixing nip 201 to the diameter D of the endless belt 210. The larger a value of the ratio N/D, the smaller the value of the height H of the endless belt 210. For example, a relation between the ratio H/D of the height H of the endless belt 210 to the diameter D of the endless belt 210 and the ratio N/D of the length N of the fixing nip 201 to the diameter D of the endless belt 210 may be determined by Equation 1:

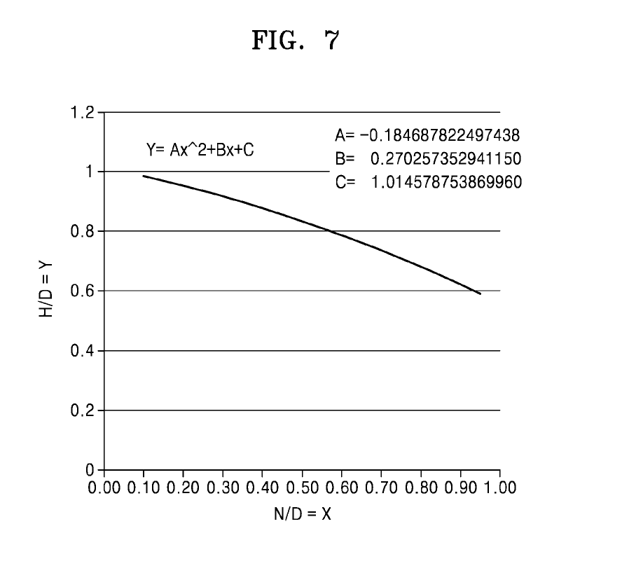

Y=AX²+BX+C (1)

where Y is the ratio H/D, and X is the ratio N/D. The ratio H/D with respect to the ratio N/D may be obtained by calculating coefficients A, B, and C from Equation 1, and the height H may be obtained from the ratio H/D. FIG. 7 illustrates an example of the ratio H/D with respect to the ratio N/D that may be obtained from Equation 1. A length N of the fixing nip 201 through which a satisfactory fixedness may be obtained may be determined, and the height H corresponding to the length N may be obtained from FIG. 7.

As illustrated in FIG. 5, a torsional force F acts on the endless belt 210. A drive stability of the endless belt 210 may be secured by increasing a component force Ft of the driving direction of the endless belt 210 more, that is, a tangential direction of the torsional force F than a component force Fn in a normal direction of the torsional force F in the second bent portion 412. That is, a position of the second bent portion 412 may be determined so that the ratio Fn/F of the component force Fn to the torsional force F is less than 0.5 or the component force Fn is less than the component force Ft. The condition may be satisfied when a height h of the second bent portion 412 from the fixing nip 201 is within a range of about 4% to about 10% of the height H of the endless belt 210 when being freely transformed.

Since the endless belt 210 may be supported via multiple points by the first and second bent portions 411 and 412 at the upstream side of the fixing nip 201, a concentration of stress may be relieved, and thus, the life of the endless belt 210 may be maintained. When the torsional force F pulling in the moving direction of the recording medium P acts on the endless belt 210, the endless belt 210 is supported by the first bent portion 411 and the second bent portion 412 that is more upstream than the first bent portion 411. Since the component force Ft in the tangential direction of the endless belt 210 is larger than the component force Fn in the normal direction, a wobble and a torsion of the endless belt 210 are suppressed, and thus, the endless belt 210 may be stably driven while being maintained in a free state that is closer to a design estimate. Thus, the endless belt 210 may be stably driven although the guide bush 260 is omitted. When disposing the guide bush 260, the inner guide portion 261 may be disposed so as to be spaced apart, for example, by 1 mm or more, from the inner side surface of the endless belt 210. Thus, interference between the internal guide portion 261 and the endless belt 210 is reduced, and thus, a risk of damaging the endless belt 210 may be reduced. Since the component force Fn in the normal direction is decreased, a frictional force between the endless belt 210 and the second bent portion 412 is also reduced. Thus, a risk of damaging the endless belt 210 due to friction may also be reduced.

As illustrated in FIG. 2, a second guide 420 for guiding the endless belt 210 exiting from the fixing nip 201 may be disposed at a downstream side of the fixing nip 201 in the driving direction of the endless belt 210. The second guide 420 may be disposed inside the endless belt 210. The second guide 420 may include a third bent portion 423 that may be disposed at a downstream side of the fixing nip 201. For example, the third bent portion 423 may be formed by bending the guide plate 310 from the nip forming portion 221 away from the backup member 230. The third bent portion 423 guides the endless belt 210 so that the endless belt 210 passing through the fixing nip 201 is stably bent and maintains a free curve shape. The third bent portion 423 may reduce interference between the endless belt 210 and the guide bush 260. The height of the third bent portion 423 from the fixing nip 201 may be equal to that of the first bent portion 411 from the fixing nip 201.

A protrusion portion 421 may be provided between the fixing nip 201 and the third bent portion 423 and protrude toward the backup member 230 from the fixing nip 201. Even after passing through the fixing nip 201, the recording medium P may not be separated from the endless belt 210 due to an adhesive strength between toner melted on the recording medium P and the endless belt 210, and the endless belt 210 may be pulled in the moving direction of the recording medium P. The curvature of the endless belt 210 that has passed through the fixing nip 201 rapidly varies due to the protrusion portion 421, and thus, the recording medium P may be easily separated from the endless belt 210 due to the rigidity of the recording medium P. Accordingly, a torsional force that is applied to the endless belt 210 may be reduced, and furthermore a probability of a jam (e.g., a wrap-jam) occurring when the recording medium P that has passed through the fixing nip 201 is wrapped around the endless belt 210 may be reduced.

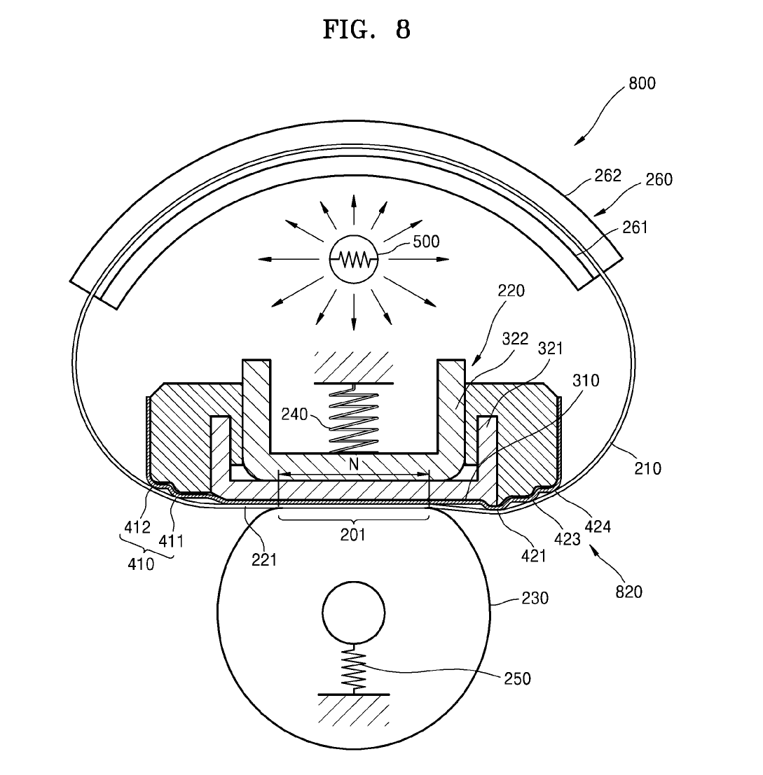

As illustrated in FIG. 8, a fixing device 800 includes a second guide 820 that includes a fourth bent portion 424 that is positioned at a downstream side of the third bent portion 423. For example, the fourth bent portion 424 may be formed by bending the guide plate 310 from the third bent portion 423 away from the backup member 230. The position of the fourth bent portion 424 is not limited thereto. For example, the fourth bent portion 424 may be positioned at a location symmetrical to that of the second bent portion 412. Due to such a configuration, the endless belt 210 may be stably guided to have a symmetrical shape about the fixing nip 201. A wobble of the endless belt 210 may be reduced, and thus, a possibility of interference with the guide bush 260 may be reduced.

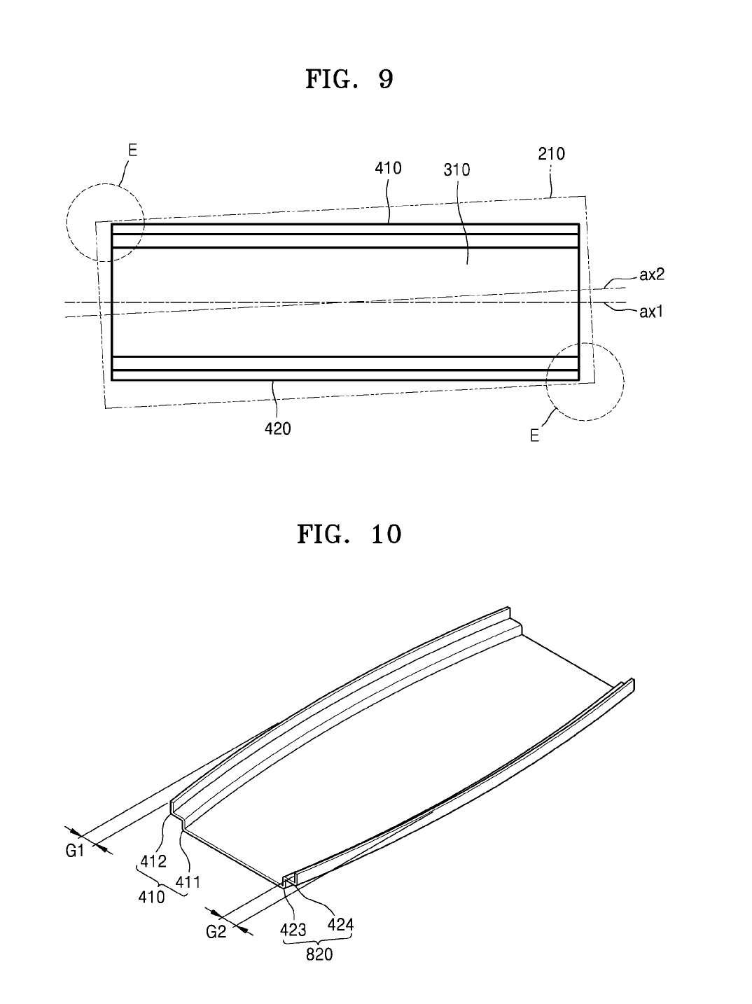

Due to friction in the fixing nip 201, a widthwise directional imbalance of a pressure that is applied to the nip forming member 220 and the backup member 230, and inclinations of axial lines ax1 and ax2 of the backup member 230 and the endless belt 210, a torsional force may act on the endless belt 210 during a drive of the endless belt 210. The endless belt 210 may incline as illustrated in FIG. 9. Thus, the endless belt 210 does not maintain line contact with the first and second guides 410 and 420 and comes in point contact with end portions E of the first and second guides 410 and 420, and thus, stress may be concentrated on the endless belt 210. To relieve the concentration of stress, the endless belt 210 and the first and second guides 410 and 420 should come in line contact with each other. As illustrated in FIG. 10, to maintain line contact between the first guide 410 and the endless belt 210, at least the second bent portion 412 may extend in a width direction perpendicular to the driving direction of the endless belt 210 and may have a curve form that is convex outwards. The first bent portion 411 may have the same form as the second bent portion 412 and may have a straight line form (although not illustrated in FIG. 10). If the first guide 410 including a plurality of second bent portions is used, the outermost second bent portion of the plurality of second bent portions has a curve form that is convex outwards. The first guide 410 having such a convex form may also be used when only the first bent portion 411 is provided. The extent G1 of convexity of the first guide 410 may be, for example, within 1 mm.

To maintain line contact between the second guide 420 and the endless belt 210, at least the fourth bent portion 424 may extend in a width direction perpendicular to the driving direction of the endless belt 210 and may have a curve form that is convex outwards. The third bent portion 423 may have the same form as the fourth bent portion 424 and may have a straight line form. The second guide 420 having such a convex form may also be applied to a case in which only the third bent portion 423 is provided. The extent G2 of convexity of the second guide 420 may be equal to the extent G1 and may be, for example, within 1 mm.

Although the endless belt 210 inclines with respect to an axial line of the backup member 230, line contact between the endless belt 210 and the first guide 410 and/or second guide 420 may be maintained to some degree, and thus, a local stress concentration of the endless belt 210 may be relieved.

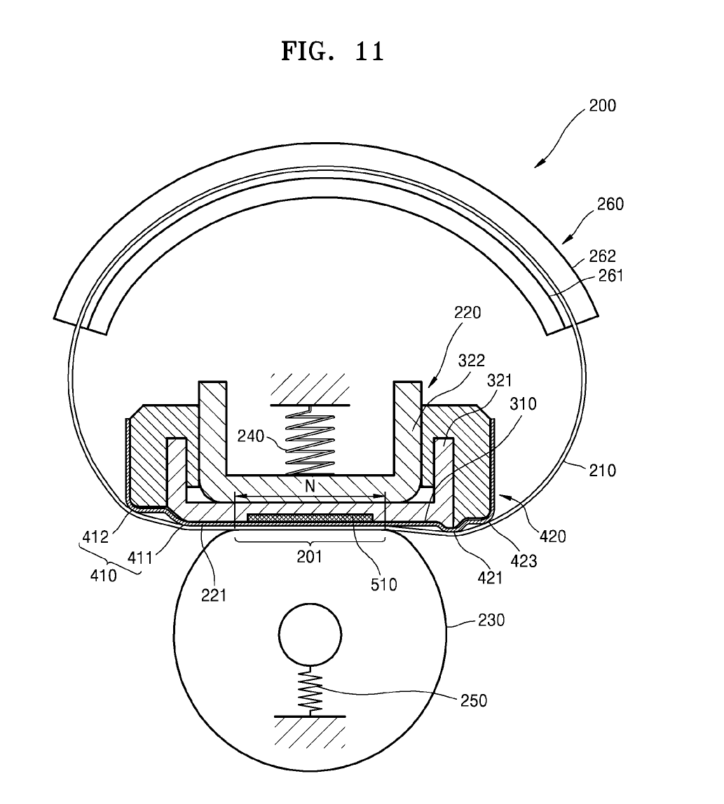

A heating device for heating the endless belt 210 may be disposed inside the endless belt 210. For example, the heating device may be a halogen lamp 500 as illustrated in FIG. 2. In addition, the heating device may be a surface type heating element 510 as illustrated in FIG. 11. For example, the surface type heating element 510 may be a ceramic heater. The surface type heating element 510 may heat the endless belt 210 through the guide plate 310 illustrated in FIG. 11. Although not illustrated, the surface type heating element 510 may be disposed at a lower side of the guide plate 310, to directly heat the endless belt 210. Various heating devices for heating the endless belt 210 may be provided, and a scope of the present inventive concept is not limited by the heating device.

While the present general inventive concept has been particularly shown and described with reference to embodiments thereof, it will be understood by those of ordinary skill in the art that various changes in form and details may be made therein without departing from the spirit and scope of the present general inventive concept as defined by the following claims.

What is claimed is:

1. A fixing device comprising:
an endless belt that is rotatable,
a backup member disposed outside the endless belt to drive the endless belt,
a nip forming member positioned inside the endless belt to be opposite to the backup member to form a fixing nip, and
a first guide positioned inside the endless belt to guide the endless belt entering the fixing nip,
wherein the first guide comprises a first bent portion disposed at an upstream side of the fixing nip to support the endless belt and a second bent portion disposed at an upstream side of the first bent portion to support the endless belt, based on a driving direction of the endless belt, and a height of the second bent portion from the fixing nip is within a range of about 4% to about 10% of a height of the endless belt when being freely transformed.

2. The fixing device of claim 1, wherein when a torsional force acting on the endless belt in the second bent portion has a value F and a component force in a normal direction of the torsional force has a value Fn, the ratio Fn/F of Fn to F is less than 0.5.

3. The fixing device of claim 1, further comprising a second guide positioned inside the endless belt to guide the endless belt exiting from the fixing nip,
wherein the second guide comprises a third bent portion disposed at a downstream side of the fixing nip to support the endless belt.

4. The fixing device of claim 3, wherein a height of the first bent portion from the fixing nip is equal to that of the third bent portion from the fixing nip.

5. The fixing device of claim 3, further comprising a protrusion portion protruding towards the backup member with respect to the fixing nip, the protrusion portion being disposed between the third bent portion and the fixing nip.

6. The fixing device of claim 3, wherein the second guide further comprises a fourth bent portion positioned at a downstream side of the third bent portion to support the endless belt.

7. The fixing device of claim 1, wherein the first guide extends in a width direction orthogonal to the driving direction of the endless belt and has a bent shape that is convex outwards with respect to the fixing nip.

8. The fixing device of claim 3, wherein the second guide extends in a width direction orthogonal to the driving direction of the endless belt and has a bent shape that is convex outwards with respect to the fixing nip.

9. An image forming apparatus comprising:
a printing unit that forms a visible toner image on a recording medium, and
the fixing device of claim 1, which fixes the visible toner image onto the recording medium.

10. The image forming apparatus of claim 9, wherein when a torsional force acting on the endless belt in the second bent portion has a value F and a component force in a normal direction of the torsional force has a value Fn, the ratio Fn/F of Fn to F is less than 0.5.

11. The image forming apparatus of claim 9, wherein the fixing device further comprises a second guide positioned inside the endless belt to guide the endless belt exiting from the fixing nip, the second guide comprising a third bent portion disposed at a downstream side of the fixing nip to support the endless belt.

12. The image forming apparatus of claim 11, wherein a height of the first bent portion from the fixing nip is equal to that of the third bent portion from the fixing nip.

13. The image forming apparatus of claim 11, wherein the fixing device further comprises a protrusion portion protruding towards the backup member with respect to the fixing nip, the protrusion portion being disposed between the third bent portion and the fixing nip.

14. The image forming apparatus of claim 11, wherein the second guide further comprises a fourth bent portion positioned at a downstream side of the third bent portion to support the endless belt.

15. The image forming apparatus of claim 9, wherein the first guide extends in a width direction orthogonal to the driving direction of the endless belt and has a bent shape that is convex outwards with respect to the fixing nip.

16. The image forming apparatus of claim 11, wherein the second guide extends in a width direction orthogonal to the driving direction of the endless belt and has a bent shape that is convex outwards with respect to the fixing nip.

17. A fixing device comprising:
an endless belt that is rotatable,
a backup member disposed outside the endless belt to drive the endless belt,
a nip forming member positioned inside the endless belt to be opposite to the backup member to form a fixing nip, and
a first guide positioned inside the endless belt to guide the endless belt entering the fixing nip,
wherein the first guide extends in a width direction orthogonal to a driving direction of the endless belt and has a bent shape that is convex outwards with respect to the fixing nip.

18. The fixing device of claim 17, wherein the first guide comprises a first bent portion disposed at an upstream side of the fixing nip to support the endless belt and a second bent portion disposed at an upstream side of the first bent portion to support the endless belt, based on a driving direction of the endless belt.

19. The fixing device of claim 18, wherein a height of the second bent portion from the fixing nip is within a range of about 4% to about 10% of a height of the endless belt when being freely transformed.

20. The fixing device of claim 19, wherein when a torsional force acting on the endless belt in the second bent portion has a value F and a component force in a normal direction of the torsional force has a value Fn, the ratio Fn/F of Fn to F is less than 0.5.
